(19) United States
(12) Patent Application Publication
(10) Pub. No.: US 2014/0057477 A1
(43) Pub. Date: Feb. 27, 2014

(54) LOCKING ELECTRICAL RECEPTACLE

(71) Applicant: GREGORY RAPTIS, CROTHERSVILLE, IN (US)

(72) Inventor: GREGORY RAPTIS, CROTHERSVILLE, IN (US)

(21) Appl. No.: 13/746,613

(22) Filed: Jan. 22, 2013

Related U.S. Application Data
(60) Provisional application No. 61/588,966, filed on Jan. 20, 2012.

(51) Int. Cl. H01R 13/639

(52) U.S. Cl. CPC H01R 13/639
USPC 439/346

(57) ABSTRACT

A locking electrical receptacle includes a housing having a pair of openings and contains a pair of prong clips adapted to be connected to a source of electricity and to engage a pair of male prongs inserted through the pair of openings. A push button having a pair of locking surfaces, a pair of unlocking surfaces and a pair of ramp surfaces is positioned in the housing and extends out of the housing. A pair of locking elements are positioned within the housing and movable between a locked position, where the pair locking elements are adapted to lock a pair of male prongs inserted through the pair of openings in the housing, and an unlocked position, where the male prongs are unlocked and may be removed from the pair of openings. The pair of locking elements engage the pair of locking surfaces of the push button when in the locked position, the pair of unlocking surfaces when in the unlocked position and the pair of ramp surfaces when moving between the locked and unlocked positions.

### CLAIM OF PRIORITY

This application claims priority to U.S. Provisional Patent Application No. 61/588,966, filed Jan. 20, 2012, the contents of which are hereby incorporated by reference.

### FIELD OF THE INVENTION

The present invention relates generally to female electrical receptacles for receiving the prongs of a male plug and, in particular, to a female electrical receptacle that automatically engages and locks the prongs of a male plug that are inserted therein and that may be manually actuated to release the prongs for removal of the male plug.

### BRIEF DESCRIPTION OF THE DRAWINGS

FIG. 1 is a front perspective view of an embodiment of the locking electrical receptacle of the invention;

FIG. 2 is a rear perspective view of the locking electrical receptacle of FIG. 1;

FIG. 3 is an exploded rear perspective view of the locking electrical receptacle of FIGS. 1 and 2;

FIG. 4 is an enlarged front perspective view of the divider of the locking electrical receptacle of FIG. 3;

FIG. 5 is an enlarged front perspective view of the button housing of the locking electrical receptacle of FIG. 3;

FIG. 6 is an enlarged front perspective view of the push button of the locking electrical receptacle of FIG. 3;

FIG. 7 is side elevational view of the locking electrical receptacle of FIGS. 1-6;

FIG. 8 is a cross sectional view of the locking electrical receptacle taken along line 8-8 of FIG. 7;

FIG. 9 is a cross sectional view of the locking electrical receptacle taken along line 9-9 of FIG. 7;

FIG. 10 is a cross sectional view of the locking electrical receptacle taken along line 10-10 of FIG. 7;

FIG. 11 is an exploded rear perspective view of a second embodiment of the locking electrical receptacle of the present invention;

FIG. 12 is an enlarged front perspective view of the divider of the locking electrical receptacle of FIG. 11;

FIG. 13 is side elevational view of the locking electrical receptacle of FIGS. 11 and 12;

FIGS. 14A and 14B are cross sectional views of the locking electrical receptacle taken along line 14-14 of FIG. 13 showing the prongs of a male plug inserted and locked and unlocked and being removed, respectively;

FIGS. 15A and 15B are a cross sectional views of the locking electrical receptacle taken along line 15-15 of FIG. 13 showing the prongs of a male plug inserted and locked and unlocked and being removed, respectively.

### DETAILED DESCRIPTION OF EMBODIMENTS

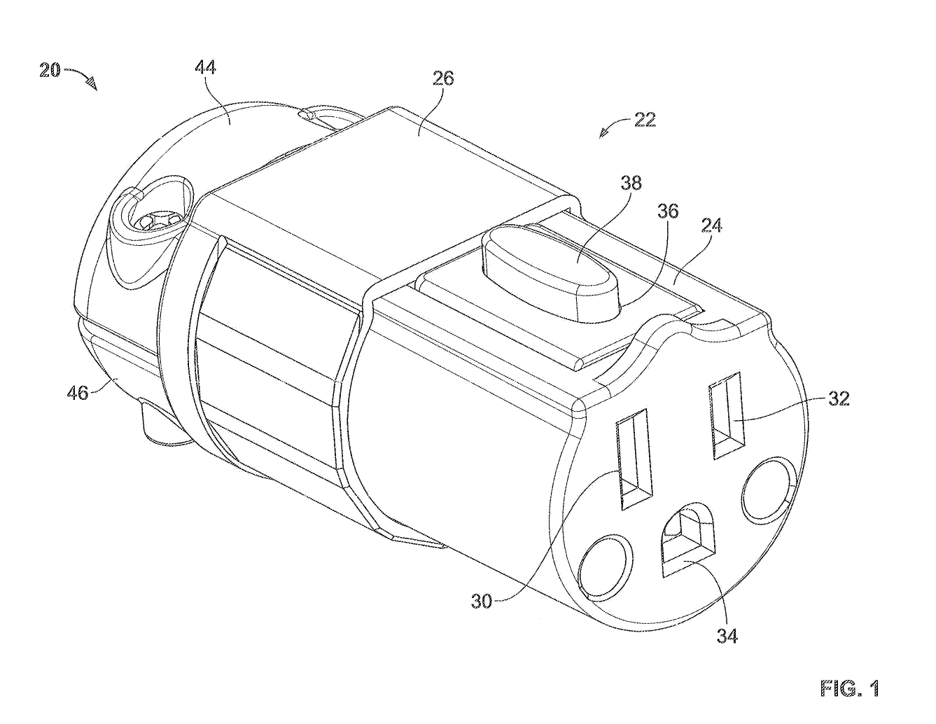

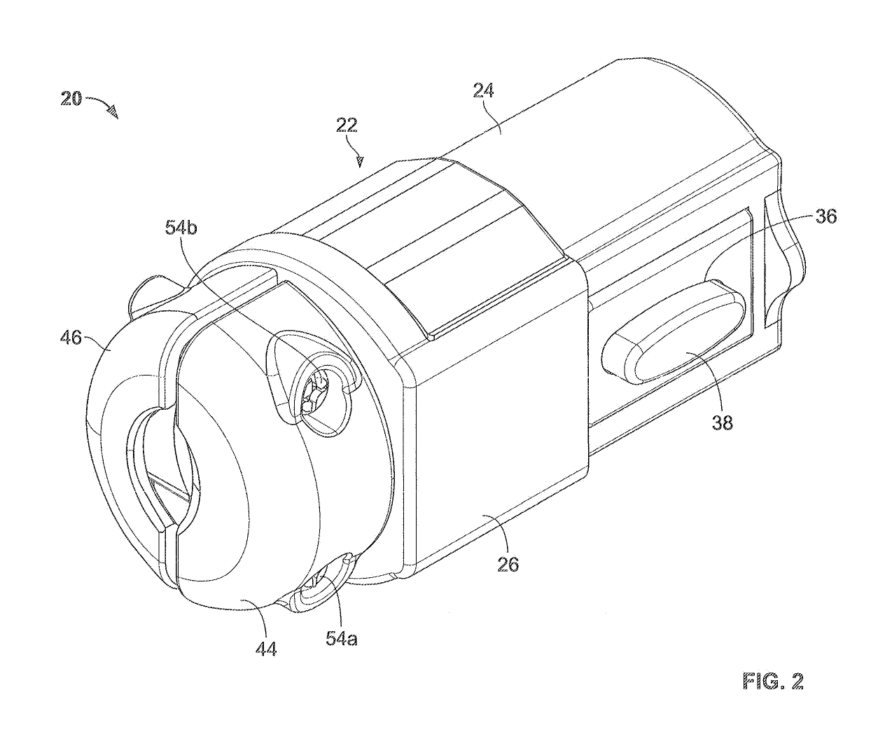

An embodiment of the locking electrical receptacle of the present invention is indicated in general at 20 in FIGS. 1 and 2. This particular embodiment takes the form of a dead front that is mounted on an electrical cord, such as an extension cord or the like. It should be understood that the locking electrical receptacle of the invention could take the form of any electrical receptacle, including, but not limited to, a wall-mounted receptacle, a receptacle box mounted on the surface of a stud or a wall, a receptacle mounted to a machine, etc.

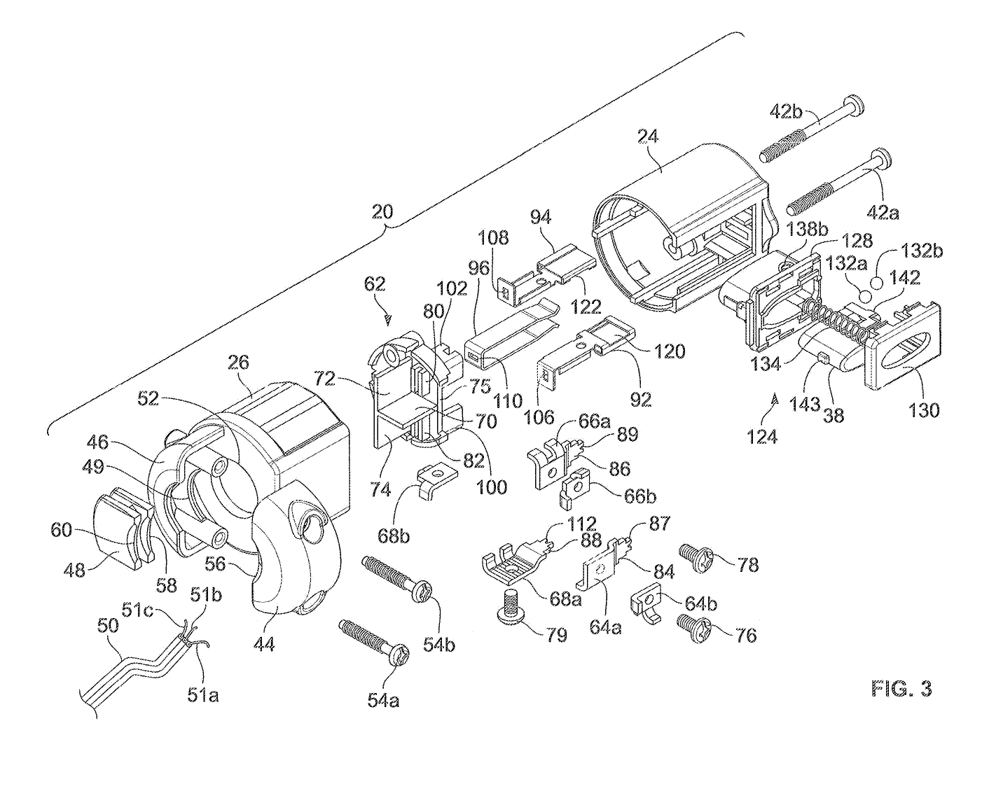

With reference to FIGS. 1 and 2, the receptacle features a housing, indicated in general at 22, that includes a front shell 24 and a rear shell 26. As shown in FIG. 1, the front shell includes neutral prong opening 30, hot prong opening 32 and ground prong opening 34. The front shell also includes an opening 36 through which push button 38 passes. With reference to FIG. 3, the front and rear shells of the housing are held together by screws 42a and 42b. The front and rear shells of the housing are preferably constructed from plastic.

As also illustrated in FIG. 3, the housing includes a cord clamping assembly which features a generally C-shaped removable clamping member 44, a corresponding fixed clamping member 46 of the rear shell 26 as well as a bifurcated spacer plate 48. In use, spacer plate 48 is positioned on arc-shaped mounting surface 49 and an electrical cord 50 passes through the opening 52 of the rear shell 26. Removable clamping member 44 is then placed in engagement with the fixed clamping member 46 and screws 54a and 54b are used to secure the assembly with the cord engaged and secured by clamping surfaces 56 and 58 and 60. For larger diameter electrical cords, spacer plate 48 may be discarded and mounting surface 49 may be used as a clamping surface in cooperation with clamping surface 56.

Housing 22 defines an interior chamber that, with reference to FIG. 3, is divided into two sections by a divider, indicated in general at 62. Divider 62 is preferably constructed from molded plastic. The rear interior section houses metal contact plates 64a and 64b, 66a and 66b, and 68a and 68b and receives the end of the electrical cord upon which the receptacle is mounted. Divider 62 includes walls 70, 72 and 74 which, along with the divider main wall 75, define three compartments, one for each pair of contact plates. More specifically, contact plates 66a and 66b are positioned within the compartment formed by walls 70, 72 and 75, contact plates 64a and 64b are positioned within the compartment formed by walls 70, 74 and 75 and contact plates 68a and 68b are positioned by the compartment defined under walls 72, 74 and 75. When the receptacle is mounted on the end of an electrical cord 50, each pair of contact plates receives one of the three conductors or strands of conductors 51a, 51b or 51c of the electrical cord there between. Alternatively, conductors or strands of conductors 51a, 52b and 51c may be part of another source of electricity, such as the electrical wiring of a home or the like. Contact plates 64a and 64b are secured together by screw 76, contact plates 66a and 66b are secured together by screw 78 and contact plates 68a and 68b are secured together by screw 79.

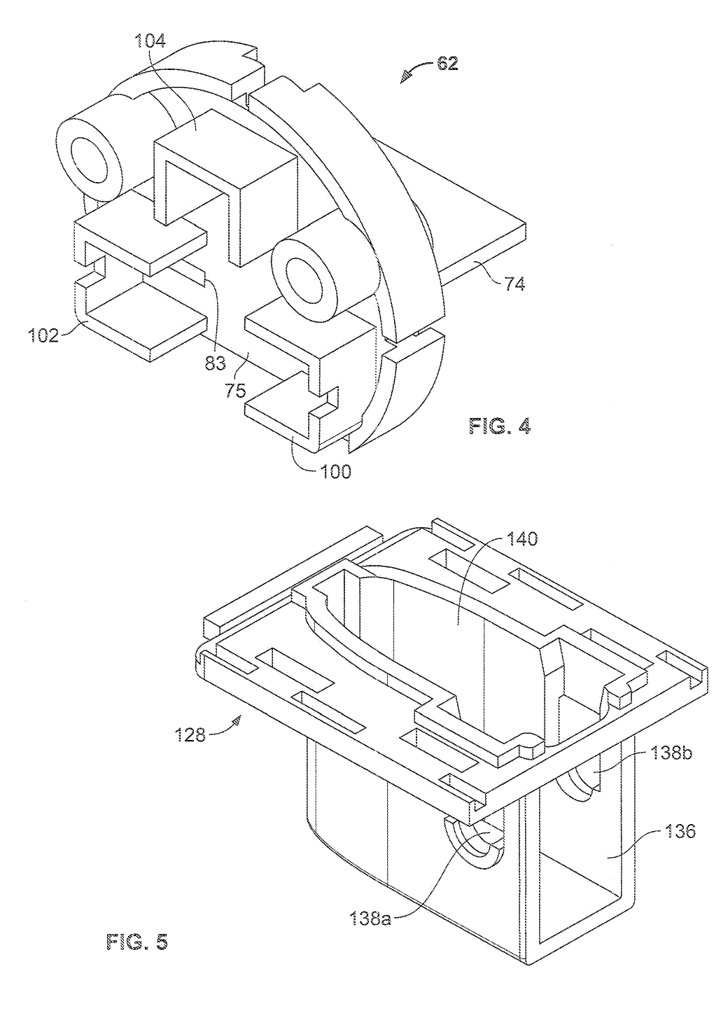

The divider main wall 75 features trough protrusions 80 and 82, with an opening though the main wall 75 at the bottom of each trough, an example of which may be viewed at 83 in FIG. 4. Troughs 80 and 82 receive extension 84 of contact plate 64a and extension 86 of contact plate 66a, respectively. The bifurcated connector ends 87 and 89 of each extension 84 and 86 pass through the corresponding openings through the main wall 75. A similar trough protrusion and main wall opening (not visible) are also formed for extension 88 of contact plate 68a.

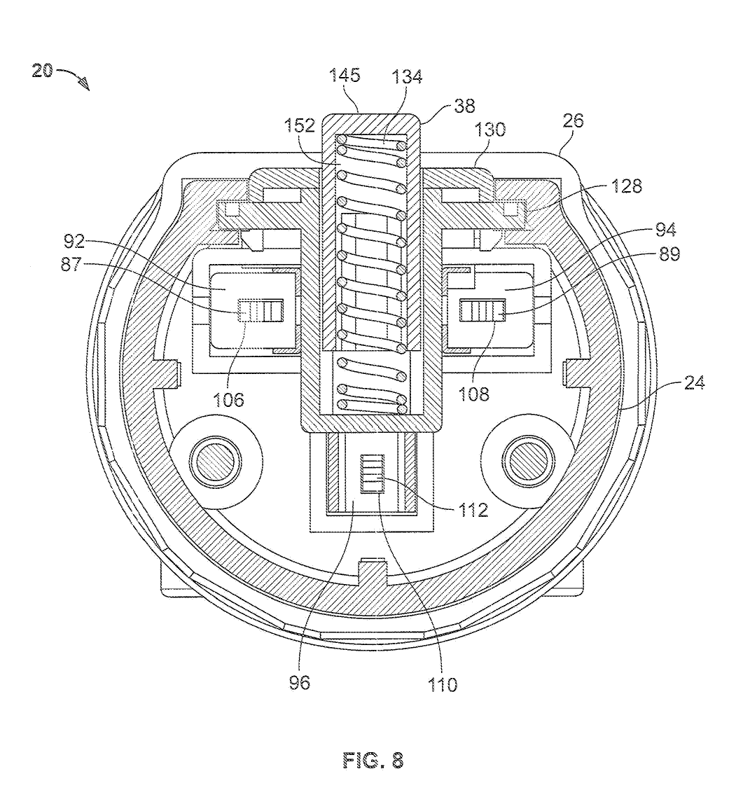

The front interior section of the housing contains the prong clips and the locking assembly. More specifically, a neutral prong clip 92, a hot prong clip 94 and a ground prong clip 96 are made from metal and are shaped so as to be attached to the divider 62 by U-shaped protrusions 100, 102 and 104, illustrated in FIG. 4, respectively. Hot prong clip 94 features opening 108 which receives bifurcated connector end 89 of contact plate 66a through opening 83 (FIG. 4) of divider main wall 75. The connection may be secured by soldering or other methods known in the art. As illustrated in FIG. 8, the bifurcated connector ends 87 and 112 of contact plates 64a and 68a are connected to openings 106 and 110 of the neutral prong clip and ground prong clip, respectively, in a similar fashion.

The leading ends of the neutral prong clip 92, the hot prong clip 94 and the ground prong clip 96 are positioned adjacent to the interior side of openings 30, 32 and 34 of the housing front shell 24 (FIG. 1), respectively. As illustrated in FIG. 3, the neutral prong clip 92 features a window 120 adjacent to its leading end while hot prong clip 94 features a window 122 adjacent to its leading end.

With reference to FIG. 3, the locking assembly, indicated in general at 124, includes the push button 38, a push button housing 128, a push button housing cover 130, a pair of locking balls 132a and 132b (preferably constructed of steel) and a compression coil spring 134 (also preferably constructed of steel). The push button, push button housing and push button housing cover are preferably constructed from molded plastic.

As illustrated in FIG. 5, the push button housing 128 features an open front 136, a pair of locking ball sockets 138a and 138b and an interior 140.

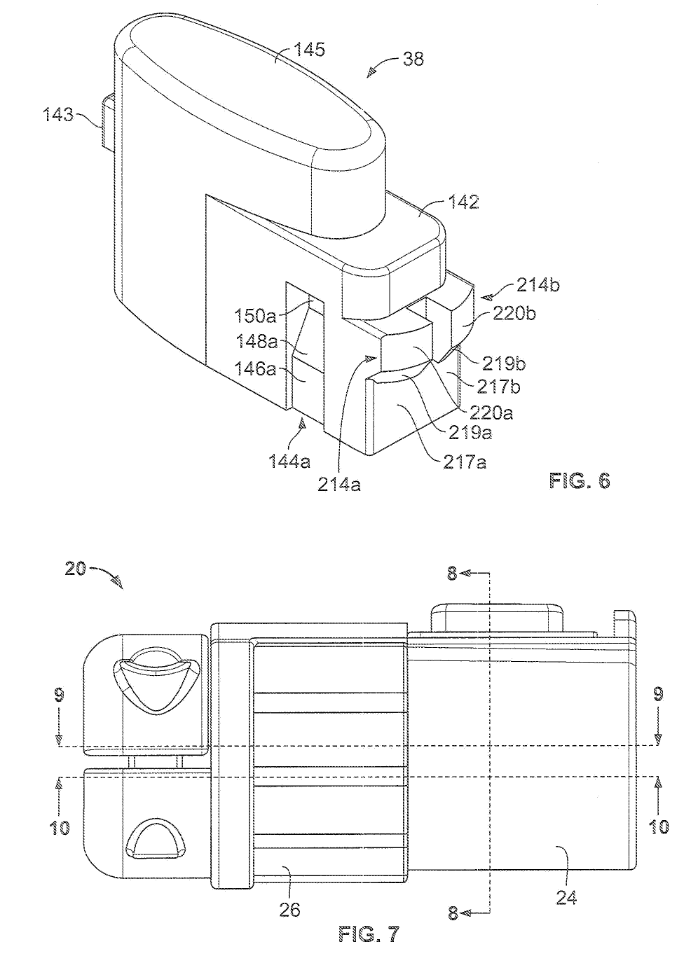

As shown in FIG. 6, the push button 38 includes a stop shoulder 142 and a stop tab 143. In addition, the push button includes a pushing surface 145 and a locking ball recess, indicated in general at 144a, which includes a locking surface 146a, a ramp surface 148a and an unlocking surface 150a. The push button features an identical locking ball recess on the opposite side.

The components of FIGS. 3-6 are shown in an assembled configuration in FIGS. 1, 2 and 7-10.

As illustrated in FIG. 8, the push button 38 features an interior bore 152 within which coil spring 134 is positioned. The bottom of the coil spring engages the bottom of push button housing 128 while the top of the coil spring engages the interior surface of the top of the push button 38. The push button housing cover 130 is secured to the push button housing 128 and upward travel of the push button 38 is limited by engagement of the push button stop shoulder 142 and the stop tab 143 (FIG. 6) with the push button housing cover 130. The pushing surface 145 of the push button protrudes out of the top of the receptacle housing so that a user may actuate the push button 38.

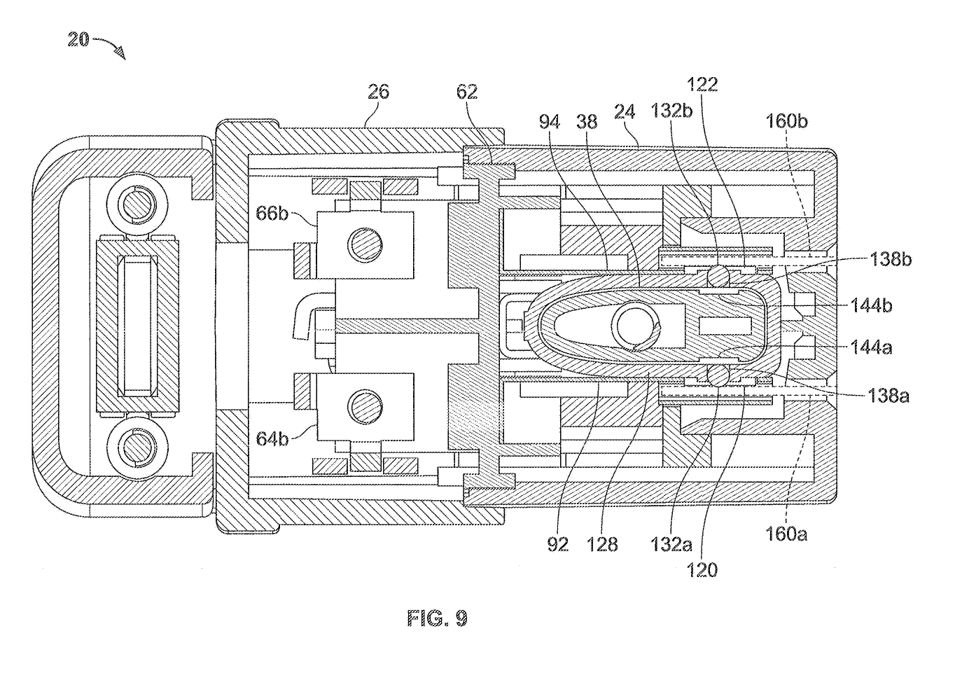

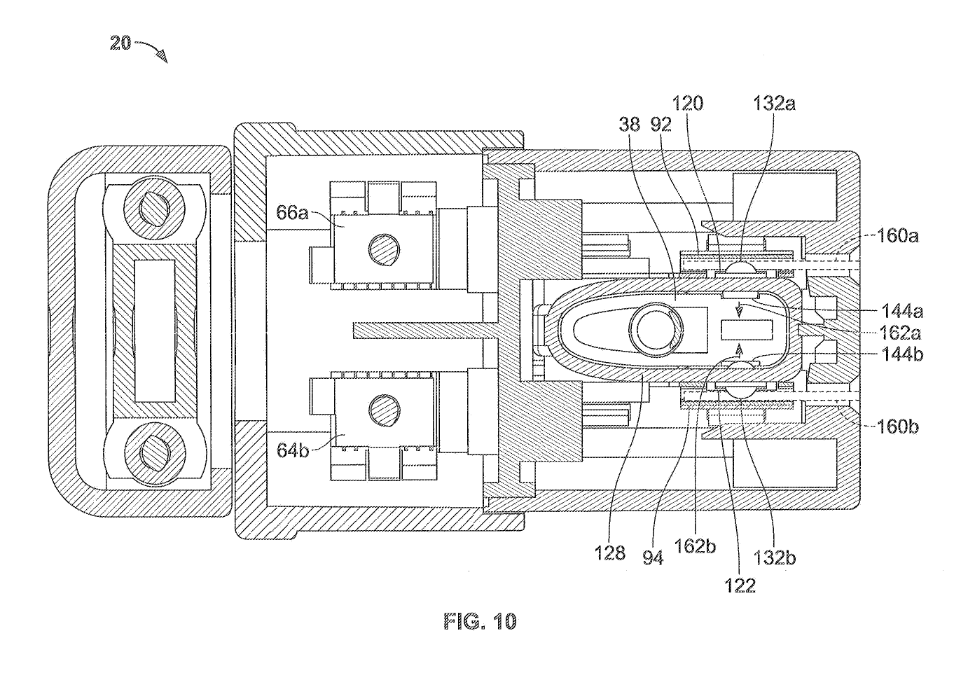

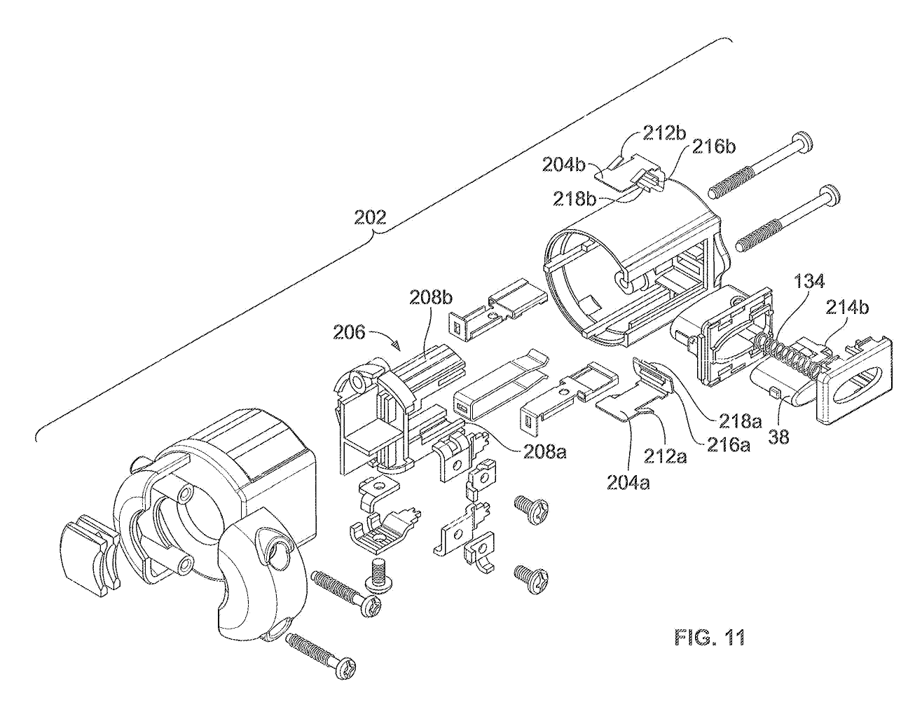

As illustrated in FIGS. 9 and 10, locking balls 132a and 132b are positioned within the locking ball recesses 144a and 144b of push button 38 and partially pass through locking ball sockets 138a and 138b of the locking ball housing 128, and the windows 120 and 122 of the prong clips 92 and 94, respectively. When male plug neutral and hot prongs, illustrated in phantom at 160a and 160b in FIGS. 9 and 10, respectively, are inserted through the slots 30 and 32 (FIG. 1) of the receptacle, the locking balls 132a and 132b engage them and lock them in the inserted position illustrated in FIGS. 9 and 10. At this point, when push button 38 is not being pressed, locking ball 132a is positioned on, with reference to FIG. 6, the locking surface 146a of the locking ball recess of the push button 38 so as to be in the extended position (with respect to the push button housing 128) illustrated in FIGS. 9 and 10. Locking ball 132b is positioned on a similar locking surface on the opposite side of the push button. As a result, the male plug prongs are locked within the receptacle 20.

The male plug prongs 160a and 160b of FIGS. 9 and 10 may be released by a user if he or she presses down on the pushing surface 145 (FIG. 6) of the push button 38, against the force of compression coil spring 34. Such action causes locking ball 132a to travel down ramp surface 148a (FIG. 6) to unlocking surface 150a as the push button 38 moves downwards. As a result, locking ball 132a is free to be pushed or retracted back into the push button housing 128 (arrow 162a of FIG. 10). Locking ball 132b travels in a similar fashion down its corresponding ramp surface to an unlocking surface on the opposite side of push button 38 so that it is also free to be pushed or retracted into the push button housing 128 (arrow 162b of FIG. 10). As a result, the male plug prongs 160a and 160b of FIGS. 9 and 10 may be withdrawn so that the male plug is removed from the receptacle 20.

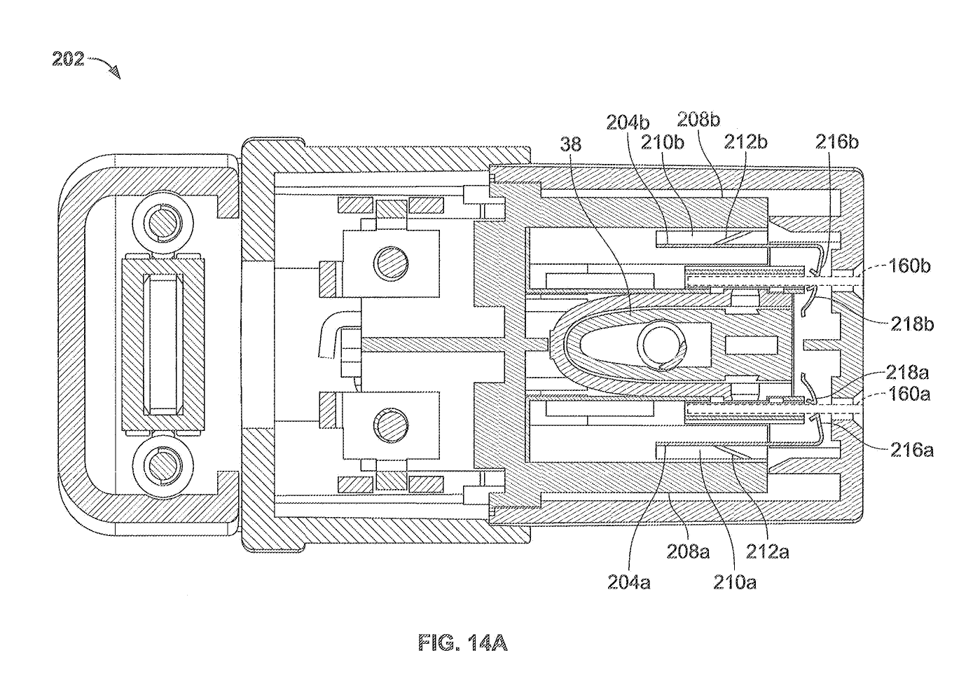

A second embodiment of the locking electrical receptacle of the invention is indicated in general at 202 in FIGS. 11 and 13-16b. In this embodiment, the locking balls (132a and 132b of FIGS. 3, 9 and 10) have been replaced with locking springs, illustrated at 204a and 204b in FIG. 11. Other than as described below, the construction of this second embodiment is identical to the construction of the embodiment of FIGS. 1-10.

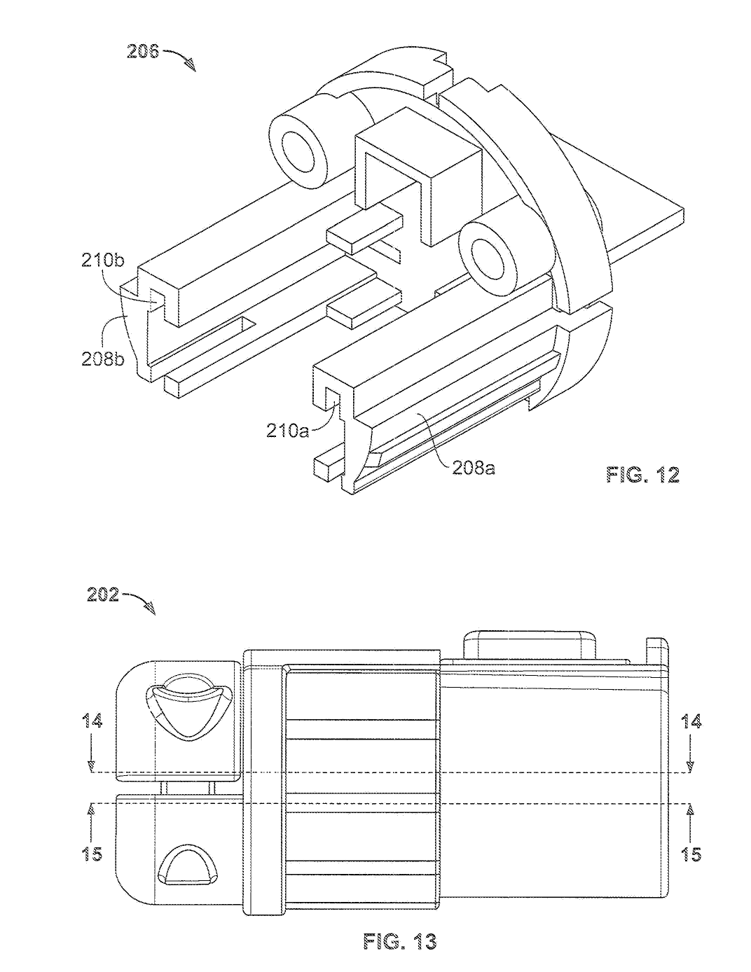

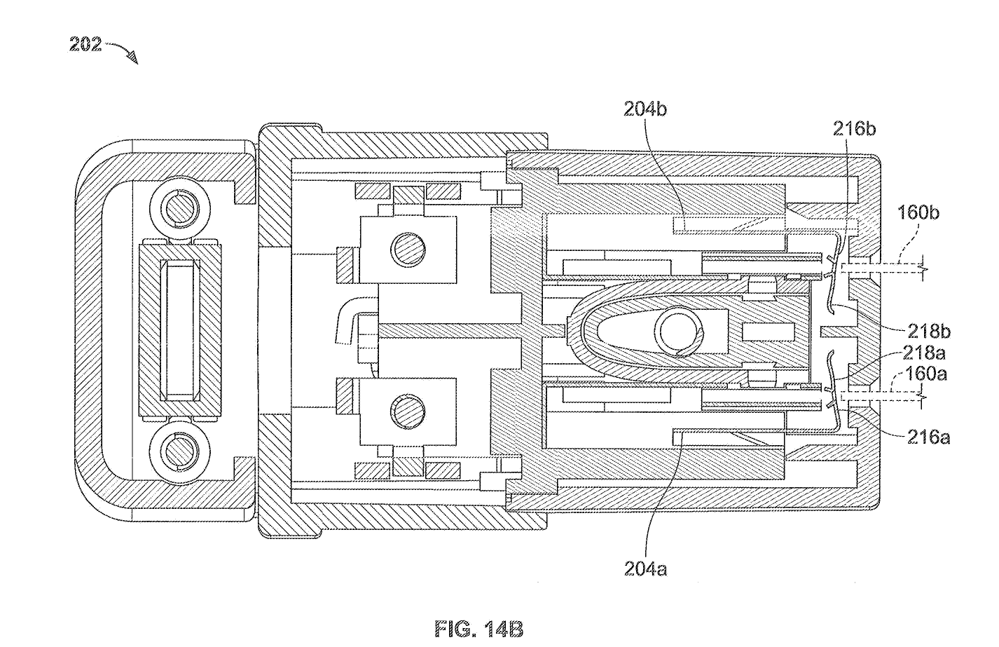

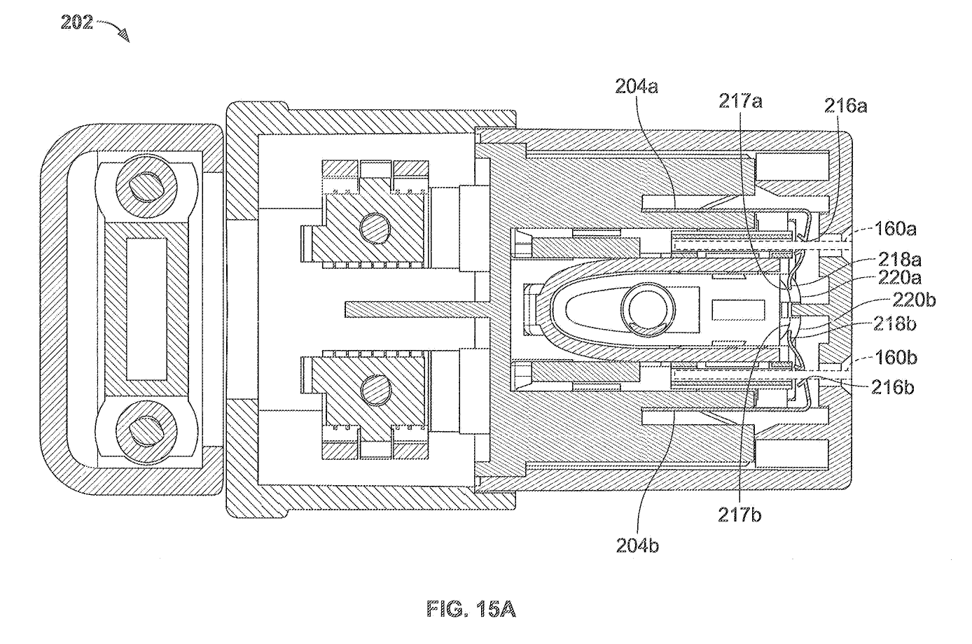

With reference to FIGS. 11 and 12, the divider 206 of the locking electrical receptacle 202 features a pair of elongated protrusions 208a and 208b. Elongated protrusions 208a and 208b have slots 210a and 210b, respectively, to receive locking springs 204a and 204b. As illustrated in FIGS. 11 and 14A, locking spring 204a features tabs 212a that engage the interior of slot 210a of protrusion 208a to secure the locking spring to the divider 206. As also illustrated in FIGS. 11 and 14A, locking spring 204b similarly features tabs 212b that engage the interior of slot 210b of protrusion 208b to secure the locking spring to the divider 206.

With reference to FIG. 6, the front of push button 38 is provided with locking wedges 214a and 214b. Locking wedge 214a features locking surface 217a, ramp surface 219a and unlocking surface 220a. Locking wedge 214b features locking surface 217b, ramp surface 219b and unlocking surface 220b. It should be noted that the locking ball recesses (144a) are not used in this embodiment of the locking electrical receptacle. The locking wedges 214a and 214b of FIG. 6 protrude and extend out of the open front 136 (FIG. 5) of the push button housing 128.

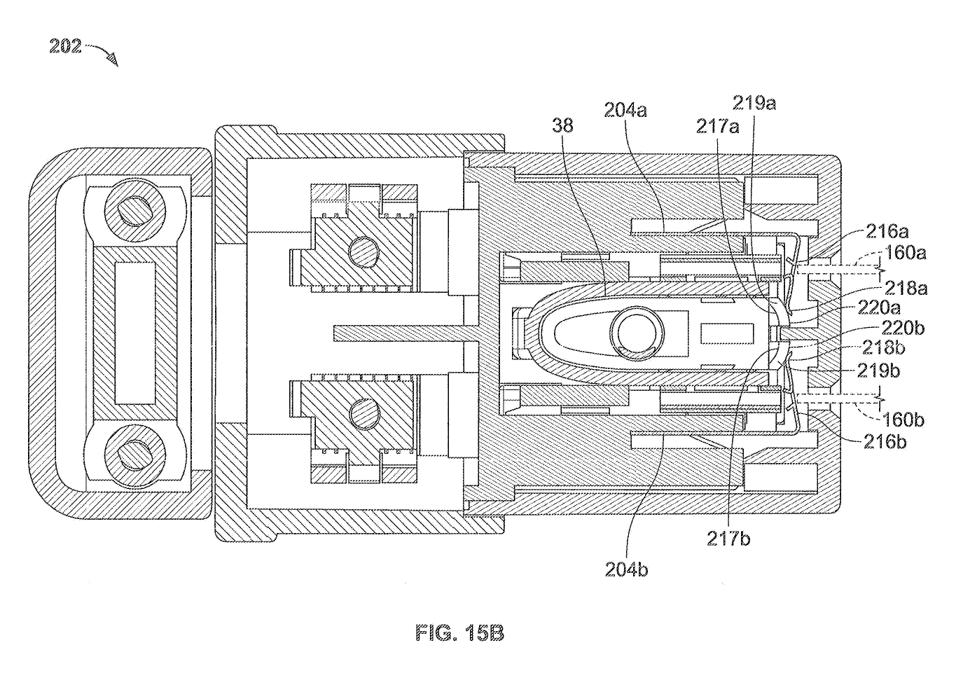

As illustrated in FIGS. 11, 14A and 15A, locking spring 204a features a lock opening 216a and an inwardly-turned distal end 218a, while locking spring 204b features a lock opening 216b and an inwardly-turned distal end 218b. When push button 38 is not being pressed, the distal ends 218a and 218b of the locking springs 204a and 204b are positioned adjacent to locking surfaces 217a and 217b (FIG. 6) of the push button and are in the positions illustrated in FIGS. 14A and 15A.

When male plug neutral and hot prongs, illustrated in phantom at 160a and 160b in FIGS. 14A and 15A, are inserted through the slots of the receptacle, the lock openings 216a and 216b of the locking springs engage them and lock them in the inserted position illustrated in FIGS. 14A and 15A. More specifically, the lock openings 216a and 216b are sized, positioned and oriented on the locking springs so that they engage, pinch and lock the male plug prongs 160a and 160b after they are inserted into the receptacle 202.

The male plug prongs 160a and 160b of FIGS. 14A and 15A may be released by a user if he or she presses down on the pushing surface 145 (FIG. 6) of the push button 38, against the force of compression coil spring 134 (FIG. 11). Such action causes the push button 38 to move downwards so that the distal ends 218a and 218b of the locking springs move (with reference to FIG. 6) up ramp surfaces 219a and 219b of the locking wedges 214a and 214b to the unlocking surfaces 220a and 220b. At this point, the locking springs 204a and 204b are in the configuration illustrated in FIGS. 14B and 15B. This causes the planes of the locking openings 216a and 216b to be more perpendicular with respect to the plane of each prong 160a and 160b so that the male plug prongs, and thus the male plug, are free to be removed from the receptacle 202.

While the preferred embodiments of the invention have been shown and described, it will be apparent to those skilled in the art that changes and modifications may be made therein without departing from the spirit of the invention, the scope of which is defined by the appended claims.

What is claimed is:

1. A locking electrical receptacle comprising:
a. a housing having a pair of openings and containing a pair of prong clips adapted to be connected to a source of electricity and to engage a pair of male prongs inserted through the pair of openings;
b. a push button having a pair of locking surfaces, a pair of unlocking surfaces and a pair of ramp surfaces positioned there between, said push button positioned so that the pair of locking surfaces, pair of unlocking surfaces and pair of ramp surfaces are positioned within the housing with said push button extending out of the housing;
c. a pair of locking elements positioned within the housing and movable between a locked position where the pair locking elements are adapted to lock the pair of male prongs inserted through the pair of openings in the housing and an unlocked position where the male prongs are unlocked and may be removed from the pair of openings; and
d. said pair of locking elements engaging the pair of locking surfaces of the push button when in the locked position, the pair of unlocking surfaces when in the unlocked position and the pair of ramp surfaces when moving between the locked and unlocked positions.

2. The locking electrical receptacle of claim 1 further comprising a spring urging the push button in a direction where the pair of locking elements engage the pair of locking surfaces.

3. The locking electrical receptacle of claim 1 wherein the source of electricity is an electrical cord.

4. The locking electrical receptacle of claim 1 wherein the pair of locking elements includes a pair of locking balls.

5. The locking electrical receptacle of claim 4 further comprising a push button housing positioned within the housing, said push button housing including a pair of locking ball sockets within which the locking balls are positioned and through which they extend at least when in the locked position.

6. The locking receptacle of claim 4 wherein the push button includes a pair of locking ball recesses containing the pair of locking surfaces, unlocking surfaces and ramp surfaces.

7. The locking receptacle of claim 1 further comprising a ground prong clip positioned within the housing, where the housing has a ground opening and the ground prong clip is adapted to engage a male ground prong inserted through the ground opening.

8. The locking receptacle of claim 1 wherein each of the pair of prong clips has a window positioned adjacent to a corresponding one of the pair of locking elements and where the pair of locking elements pass through the windows when moving into the locked position.

9. The locking receptacle of claim 1 wherein the pair of locking elements include a pair of locking springs.

10. The locking receptacle of claim 9 wherein each of the pair of locking springs includes a lock opening and a distal end portion that engages the pair of locking surfaces, unlocking surfaces and ramp surfaces and where a pair of male prongs inserted through the pair of housing openings and into engagement with the pair of prong clips passes through the lock openings and are engaged by the lock openings when the locking springs are in the locked position.

11. The locking receptacle of claim 10 wherein the distal end portion is inwardly-turned with respect to the housing.

12. The locking receptacle of claim 10 wherein the push button includes a pair of locking wedges featuring the pair of locking surfaces, unlocking surfaces and ramp surfaces.

13. The locking receptacle of claim 12 wherein the locking wedges are positioned on a front surface of the push button and the distal end portion is inwardly-turned with respect to the housing so as to be engaged by the pair of locking surfaces, unlocking surfaces and ramp surfaces.

14. A locking electrical receptacle comprising:
a. a housing defining an interior chamber having first and second openings;
b. first and second prong clips adapted to be connected to a source of electricity, said first and second prong clips positioned within the interior chamber of the housing with the first prong clip positioned adjacent to an interior side of the first opening and the second prong clip positioned adjacent to an interior side of the second opening;
c. a locking assembly positioned in the housing and including:
i) a push button extending out of the housing, said push button including a pushing surface positioned external to the housing and a first locking surface and a first unlocking surface with a first ramp surface there between positioned within the interior chamber, and a second locking surface and a second unlocking surface with a second ramp surface there between positioned within the interior chamber;
ii) a first locking element movable between a locked position where the first locking element is adapted to lock a first male prong inserted into the first prong clip and an unlocked position where the first male prong is unlocked so that it may be removed from the first prong clip;
iii) a second locking element movable between a locked position where the second locking element is adapted to lock a second male prong inserted into the second prong clip and an unlocked position where the second male prong is unlocked so that it may be removed from the second prong clip;
iv) said first locking element engaging the first locking surface of the push button when in the locked position, the first unlocking surface when in the unlocked position and the first ramp surface when moving between the locked and unlocked positions;
v) said second locking element engaging the second locking surface of the push button when in the locked position, the second unlocking surface when in the unlocked position and the second ramp surface when moving between the locked and unlocked positions.

15. The locking electrical receptacle of claim 14 further comprising a spring urging the push button in a direction where the first and second locking elements engage the first and second locking surfaces.

16. The locking electrical receptacle of claim 14 wherein the source of electricity is an electrical cord.

17. The locking electrical receptacle of claim 14 wherein the first and second locking elements include first and second locking balls.

18. The locking electrical receptacle of claim 17 further comprising a push button housing positioned within the housing, said push button housing including first and second locking ball sockets within which the first and second locking balls are respectively positioned and through which they extend at least when in the locked position.

19. The locking receptacle of claim 4 wherein the push button includes first and second locking ball recesses containing the first and second locking surfaces, the first and second unlocking surfaces and the first and second ramp surfaces.

20. The locking receptacle of claim 14 further comprising a ground prong clip positioned within the housing, where the housing has a ground opening and the ground prong clip is adapted to engage a male ground prong inserted through the ground opening.

21. The locking receptacle of claim 14 wherein each of the first and second prong clips has a window positioned adjacent to a corresponding one of the first and second locking elements and where the first and second locking elements pass through the windows when moving into the locked position.

22. The locking receptacle of claim 14 wherein the first and second locking elements include first and second locking springs.

23. The locking receptacle of claim 22 wherein each of the first and second locking springs includes a lock opening and a distal end portion that engages the first and second locking surfaces, unlocking surfaces and ramp surfaces respectively and where first and second male prongs inserted through the first and second housing openings and into engagement with the first and second prong clips passes through the lock openings and are engaged by the lock openings when the first and second locking springs are in the locked position.

24. The locking receptacle of claim 23 wherein the distal end portions are inwardly-turned with respect to the housing.

25. The locking receptacle of claim 23 wherein the push button includes a pair of locking wedges featuring the pair of locking surfaces, unlocking surfaces and ramp surfaces.

26. The locking receptacle of claim 25 wherein the locking wedges are positioned on a front surface of the push button and the distal end portion is inwardly-turned with respect to the housing so as to be engaged by the pair of locking surfaces, unlocking surfaces and ramp surfaces.
